(19) United States
(12) Patent Application Publication
(10) Pub. No.: US 2008/0178540 A1
(43) Pub. Date: Jul. 31, 2008

(54) STRUCTURAL TERMINUS IMPLEMENTED TO LIMIT EXPLOSIVE EFFECT

(75) Inventor: Heinrich Salzer, Marburg (DE)

Correspondence Address: Ursula B. Day;Henry M. Feiereisen, LLC, Suite 4714, 350 Fifth Avenue, New York, NY, 10118, US

(73) Assignee: Salzer Sicherheitstechnik GmbH, Marburg (DE)

(21) Appl. No.: 12/021,811

(22) Filed: Jan. 29, 2008

(30) Foreign Application Priority Data
Jan. 31, 2007 (DE) 20 2007 001 653.0

(51) Int. Cl. E06B 3/30; E06B 3/26; E04C 2/38

(52) U.S. Cl. 52/202; 52/656.7

(57) ABSTRACT

A structural terminus for limiting an explosive effect has at least two panel elements and a frame element situated in a gap area and includes an external frame profile situated outside a plane defined by the exterior side of the panel the elements and an internal frame profile situated inside the plane defined by the interior sides of the panel elements, an insulating profile and an adapter profile which is connected to the frame profile opposite thereto via connecting elements, disposed in longitudinal direction at the frame profile and which pass through the area of at least one insulating profile.

### CROSS-REFERENCES TO RELATED APPLICATIONS

This application claims the priority of German Patent Application Serial No. DE 20 2007 001 653.0, filed Jan. 31, 2007, pursuant to 35 U.S.C. 119(a)-(d), the subject matter of which is incorporated herein by reference.

### BACKGROUND OF THE INVENTION

The present invention relates to a structural terminus implemented to limit explosive effects and relates in particular to a structural terminus of the type which includes at least two panel elements and a frame element situated in a gap area between the panel elements, which encloses each of the two panel elements together with further frame elements, where the frame element situated in the gap area are assembled from external and internal frame profiles.

A structural terminus in the meaning of the present application is a window, a door, or another planar terminus element. The structural terminus may be openable or permanently closed and may be provided with a transparent or opaque panel. Generally known structural termini which form the species are particularly so-called window façades.

### SUMMARY OF THE INVENTION

The present invention is embodied in a structural terminus having desirable and advantageous features of an improved structural terminus to obviate prior art shortcomings and in particular, to provide a significant stiffening to the structural terminus which also has a significantly better stabilization effect.

According to one aspect of the present invention, the structural terminus implemented to limit explosive effect includes at least two panel elements and a frame element situated in a gap area between the panel elements, which, together with further frame elements encloses each of the two panel elements the frame element situated in the gap area being assembled from an external frame profile which is situated outside the plane defined by the exterior sides of the panel elements and an internal frame profile running parallel thereto, which is situated inside the plane defined by the interior sides of the panel elements at least one insulating profile being situated between the two frame profiles and an adapter profile being situated in front of the external frame profile on the outside or the internal frame profile on the inside, wherein the adapter profile is connected to the frame profile opposite thereto using connecting elements which are situated distributed in its longitudinal direction and pass through the area of the at least one insulating profile.

Another feature of the present invention is that the adapter profile is connected to the frame profile opposite thereto using connecting elements which are situated distributed in its longitudinal direction and pass through the area of the at least one insulating profile. The connection of the adapter profile to the opposing frame profile results in significant stiffening of the structural terminus in an especially simple way. In particular, according to the present invention, the particular other frame profile contributes significantly better to the stabilization effect than in the prior art, in that the insulating profile, which always forms a weak point in regard to the strength, is more or less bypassed and/or reinforced by the connecting elements. The thermal separating effect of the insulating profile is maintained as much as possible by the connecting elements, which are only provided punctually.

The connecting elements of a structural terminus according to the present invention are preferably connected to a reinforcement profile situated in the interior of the external frame profile. The structural terminus is stiffened further by the connection to a reinforcement profile in the internal frame profile.

The adapter profile of a structural terminus according to the present invention is especially preferably assembled from a reinforcement profile and a mantle profile which covers it on the exterior. The use of a reinforcement profile also causes further stiffening of the structural terminus here, the covering mantle profile being able to be adapted especially easily to the desired visual appearance of the structural terminus as a separate module.

The mantle profile is advantageously fastened to a retention profile, in particular clipped thereon, the retention profile being connected to the external or internal frame profile. The use of a separate retention profile (instead of integrating a retention unit for the mantle profile in the affected frame profile) allows the use of the particular frame profile without mantle profile or different frame profiles with the same mantle profiles in a building block system as well as the subsequent add-on of a mantle profile to an existing frame profile.

Furthermore, it is advantageous if the internal and/or external reinforcement profile of a structural terminus according to the present invention is a hollow profile, in particular a rectangular profile. The particular reinforcement profile then has an improved ratio of the rigidity to mass and material used in relation to a solid profile.

The external and internal frame profiles of a structural terminus according to the present invention are preferably connected to one another via insulating webs and the connecting elements run in an intermediate space between the insulating webs. The insulating webs ensure a thermal separation of the internal and external frame profiles.

The connecting elements of a structural terminus according to the present invention are advantageously screws or bolts. In relation to the alternative use of cast connecting elements, the structural terminus according to the present invention may be implemented more cost-effectively by using standard and mass-produced parts.

These screws or bolts are preferably guided from the exterior side of the structural terminus through holes in the external reinforcement profile and the external frame profile and screwed into a threaded hole in the interior reinforcement profile. These screws or bolts are thus not visible on the interior side of the structural terminus.

Furthermore, the external frame profile implemented as a hollow profile is preferably provided with an insert, which covers edge strips of the neighboring panel elements on both sides. The security of the structural terminus against break-ins is thus increased. The security against penetrating gunshots and explosive effect is improved, in particular if the insert is made of steel.

This insert advantageously extends over a joint between the frame element located in the gap area and at least one adjoining frame element through a recess in a lateral face of the adjoining frame element into the latter. The structural terminus is further stiffened by this overlap of the insert into the adjoining frame element.

Furthermore, on a structural terminus according to the present invention, an external reinforcement profile located in the adapter profile preferably extends on at least one side beyond the external outline of a screen frame formed by frame elements, is supported on a visible side of a structural part, and is preferably anchored there. The structural terminus is also improved further in its stability by the overlap of the reinforcement profile and the support on the exterior side of the structural part, because large forces may be introduced into the affected structural part in this way.

The reinforcement profile of a structural terminus according to the present invention located in the adapter profile is especially advantageously connected on at least one end to a soffit of the structural part by anchors. The structural terminus is also stiffened further by the anchoring of the external reinforcement profile—instead of only support.

The connection between this reinforcement profile located in the adapter profile on one hand and the structural part on the other hand preferably allows a displacement of the structural terminus, in particular the adapter profile, in a direction perpendicular to the plane of the panel elements. The connection allows an elastic and/or plastic deformation of the structural part under a pressure wave.

Such a displacement in the area of the connection between the reinforcement profile in the adapter profile and the structural part also advantageously causes energy consumption, in particular via component deformation and/or via friction. The displacement may thus dissipate at least a part of the energy content of a pressure wave impinging the structural terminus.

Advantageously, this connection between the external reinforcement profile in the anchoring element and the adapter profile has an oblong hole-bolt combination. Such a connection may thus be implemented especially simply.

In a further advantageous embodiment, at least one of the panel elements of a structural terminus according to the present invention is openable. In particular, such an openable panel element may be attached to the frame element so it is pivotable and/or tiltable. The panel element may be implemented as frameless for this purpose or have a generally known casement.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows an external front view of a terminus according to the present invention with an adapter profile,

FIG. 2a shows a first detail in vertical section and

FIG. 2b shows a second detail in vertical section,

FIG. 3a shows a third detail in horizontal section,

FIG. 3b shows a fourth detail in horizontal section and

FIG. 3c shows a fifth detail in horizontal section thereof.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

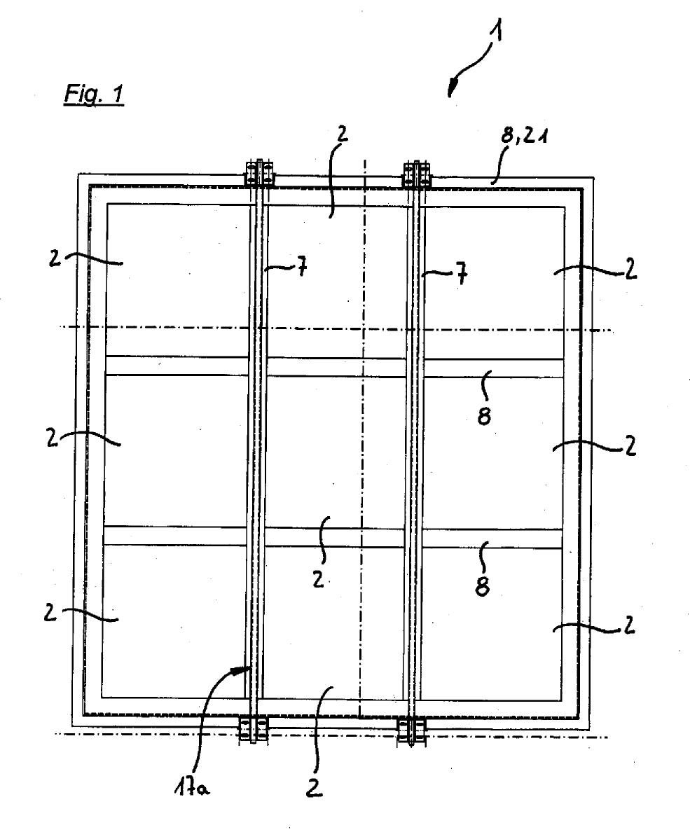

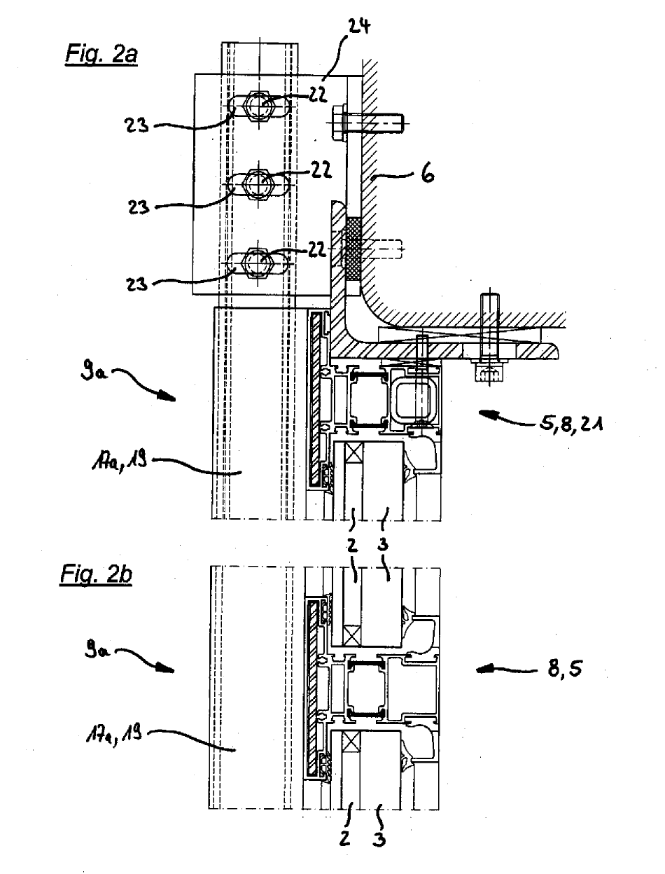

Turning now to the drawing, and in particular to FIG. 1, there is shown a so-called window façade implemented to limit explosive effect. The structural terminus 1 has nine identical panel elements 2 made of insulating glass having external safety glass 3. Frame elements 7, 8 are situated in the gap areas 4, 5 between the panel elements 2 and between the panel elements 2 and the structural wall 6. The panel elements 2 are retained in the frame elements 7, 8.

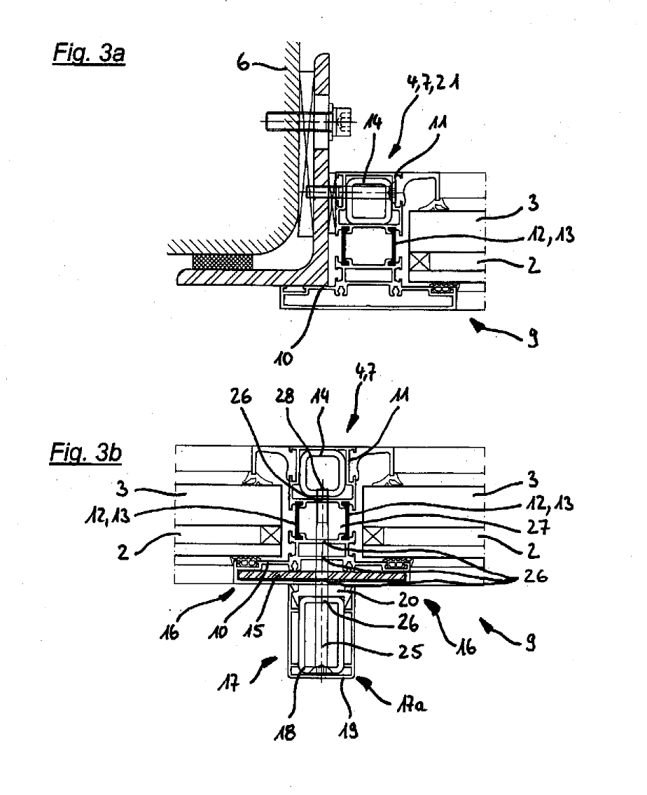

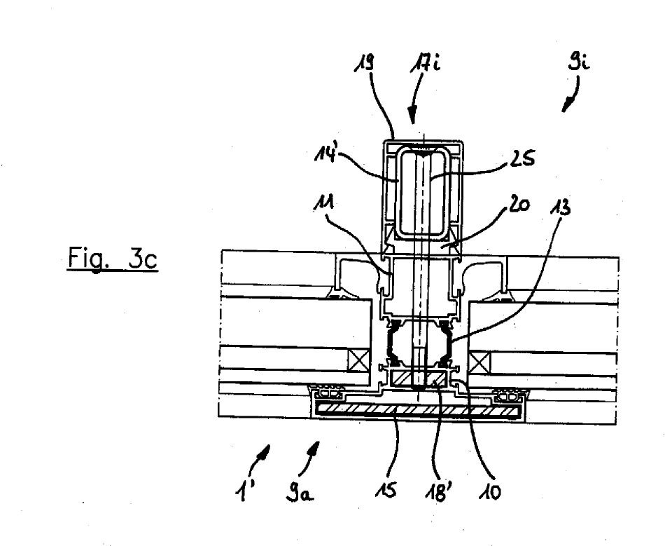

The frame elements 7 in the gap areas 4 running in the vertical direction have an external frame profile 10 on the exterior side 9 of the panel elements 2 and the structural terminus 1 and an internal frame profile 11 running parallel thereto. The structural terminus 1 has an insulating profile 12 between the external frame profile 10 and the internal frame profile 11 (FIG. 3a). The internal frame profile 11 and the external frame profile 10 are connected to one another via insulating webs 13.

The internal frame profile 11, which is implemented as a hollow profile, has an internal reinforcement profile 14 made of a rectangular tube. The external frame profile 10, which is also implemented as a hollow profile, has an insert 15, which covers the edge strips 16 of the two adjacent panel elements 2 and extends through a recess (not shown) at the point A (FIG. 1) into a particular frame element 7, 8 adjoining perpendicularly.

An adapter profile 17a is situated in front of the external frame profile 10 on the exterior side 9, which has an external reinforcement profile 18 made of a rectangular tube and a mantle profile 19 which covers it. The mantle profile 19 is clipped onto a retention profile 20, which is connected to the external frame profile 10, in particular screwed thereon. The external reinforcement profile 18 extends beyond the door frame 21 and is screwed using threaded bolts 22 into oblong holes 23 on bearing shoes 24 anchored on the structural wall 6.

The adapter profile 17a is connected to the internal frame profile 11 using connecting elements 25, namely using countersunk head screws. The connecting elements 25 run from the exterior side 9 through holes 26 in the external reinforcement profile 18 and in the external frame profile 10 and through an intermediate space 27 between the insulation webs 13 and are screwed into a threaded hole 28 in the internal reinforcement profile 14, which has a wall thickness of at least 3 mm at this point and is preferably made of steel.

FIG. 3c shows a horizontal section of an alternative embodiment of a structural terminus 1′, on whose interior side 9i an adapter profile 17i is situated. As explained in the exemplary embodiment of FIG. 3b, the internal adapter profile 17i has a retention profile 20, which is connected to the internal frame profile 11, which has no reinforcement profile in the present case. A mantle profile 19 is in turn clipped onto the retention profile 20. The adapter profile contains an internal reinforcement profile 14′ in the form of a rectangular tube. The connecting elements 13 now extend through the internal reinforcement profile 14′, as well as through the internal frame profile 11 and between the insulating webs 13 into the external frame profile 10, specifically into an external reinforcement profile 18′, which is situated in a hollow chamber of the external frame profile 10 facing toward the interior side 9i. A threaded hole, into which the threaded end section of the connection element 25 is screwed, is introduced into the reinforcement profile 18′, which is made of aluminum or steel flat material. An insert 15, which has a reinforcing effect both in regard to explosive effect inhibition, break-in inhibition, and also gunshot penetration inhibition, is again located in the hollow chamber of the external frame profile 10 facing toward the exterior side 9a.

While the invention has been illustrated and described as embodied in security window or door, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

1. A structural terminus for limiting an explosive effect comprises:
at least two panel elements,
frame elements situated in a gap area between the panel elements, wherein the frame elements which are enclosing the panel elements are assembled from an external frame profile situated outside a plane defined by exterior sides of the panel elements, a parallel extending internal frame profile situated inside a plane defined by interior sides of the panel elements with least one insulating profile disposed between the external and internal frame profile, and
an adapter profile situated in front of the external frame profile on the outside, or in front of the internal frame profile on the inside, wherein the adapter profile is connected to the exterior or interior frame profiles by connecting elements which are located along the longitudinal extension of the exterior or interior frame profiles and pass through an area of the at least one insulation profile.

2. The structural terminus according to claim 1, further comprising a reinforcement profile situated interiorly of the internal or exterior frame profile and wherein the connecting elements are connected to the reinforcement profile.

3. The structural terminus according to claim 1, the adapter profile is assembled from a reinforcement profile and a mantle profile covering it on the outside.

4. The structural terminus according to claim 3, wherein the mantle profile is fastened to a retention profile, the retention profile being connected to the internal or external frame profile.

5. The structural terminus according to claim 4, wherein the mantle profile is clipped to a retention profile,

6. The structural terminus according to claim 2, wherein the reinforcement profile is either an internal or external reinforcement profile which is a hollow profile,

7. The structural terminus according to claim 6, wherein the hollow profile has rectangular cross section.

8. The structural terminus according to claim 1, wherein the external frame profile and the internal frame profile are connected to one another via insulating webs and the connecting elements extend through an intermediate space between the insulating webs.

9. The structural terminus according to claim 1, wherein the connecting elements are screws or bolts.

10. The structural terminus according to claim 9, wherein the screws or bolts are guided from an exterior side of the structural terminus through holes in the external reinforcement profile and the external frame profile and screwed into a threaded hole in the internal reinforcement profile.

11. The structural terminus according to claim 1, wherein the external frame profile is a hollow profile and provided with an insert which covers edge strips of adjacent panel elements on both sides.

12. The structural terminus according to claim 11, wherein the insert extends over a joint between the frame elements located in the gap area and at least one adjoining frame element through a recess in a lateral face of the adjoining frame element into the latter.

13. The structural terminus according to claim 9, wherein the external reinforcement profile located in the adapter profile extends beyond the external outline of a window or door frame formed by frame elements on at least one side and is supported on an external visible side of a structure part and anchored there.

14. The structural terminus according to claims 9, wherein the external reinforcement profile located in the adapter profile is connected on at least one end to a soffit of a structure part.

15. The structural terminus according to claim 14, wherein the connection between the external reinforcement profile on one hand and the structure part on the other hand allows a displacement of the structural terminus, in a direction perpendicular to the plane of the panel elements.

16. The structural terminus according to claim 15, wherein the displacement is of the adapter profile.

17. The structural terminus according to claim 16, wherein the displacement in the area of the connection between the external reinforcement profile in the adapter profile and the structure part causes energy consumption.

18. The structural terminus according to claim 16, wherein the displacement in the area of the connection between the external reinforcement profile in the adapter profile and the structure part causes energy consumption via component deformation and/or via friction.

19. The structural terminus according to claim 18, wherein the connection between an anchoring element in the external reinforcement profile and the adapter profile has an oblong hole-bolt combination.

20. The structural terminus according to claim 1, wherein at least one of the panel elements has the capacity of being opened and at least one of being turned and tilted.
